(19) United States
(12) Patent Application Publication
(10) Pub. No.: US 2006/0045808 A1
(43) Pub. Date: Mar. 2, 2006

(54) Sensor for diagnostic measuring machine

(76) Inventor: Sang-Kyu Park, Gwangju (KR)

Correspondence Address: LADAS & PARRY LLP, 224 SOUTH MICHIGAN AVENUE, SUITE 1600, CHICAGO, IL, 60604, US

(21) Appl. No.: 10/516,815

(22) PCT Filed: Jul. 24, 2003
(86) PCT No.: PCT/KR03/01491

§ 371 Date: Dec. 6, 2004

(30) Foreign Application Priority Data
Jul. 25, 2002 (KR) 10-2002-0043961

(51) Int. Cl. G01N 21/00

(52) U.S. Cl. 422/82.05

(57) ABSTRACT

The present invention pertains to a sensor for a diagnostic device using an optical fiber and a pH sensitive high molecular weight substance, which indicates the safety of foodstuffs or is used as a medical examination device. More particularly, the present invention relates to a sensor for a diagnostic device which detects a wavelength change of reflected light using an optical spectroscope to indicate a freshness of foodstuffs or an immune condition of a human body, including a light receiving optical fiber through which light is transferred from a light source to a pH sensitive high molecular weight substance. The sensor also includes a semi-permeable membrane film part which is filled with the pH sensitive high molecular weight substance so as to detect a pH change of a subject when the subject comes into contact with the pH sensitive high molecular weight substance, receives an output end of the light receiving optical fiber and an input end of an information transferring optical fiber, and includes a reflection member inserted therein so as to reflect the light passing through the light receiving optical fiber into the information transferring optical fiber. The information transferring optical fiber transfers data including the freshness of the foodstuffs or a health condition of the human body therethrough when the light subjected to a wavelength interference by the pH sensitive high molecular weight substance advances into the optical spectroscope. Alternatively, the sensor for the diagnostic device may includes a diagnostic kit insertion member instead of the semi-permeable membrane film part. The diagnostic kit insertion member is made of a material having excellent light transmittance, receives an output end of the light receiving optical fiber and an input end of the information transferring optical fiber, and has a diagnostic kit insertion groove for receiving a diagnostic kit. At this time, the diagnostic kit includes a semi-permeable membrane member and the pH sensitive high molecular weight substance. Accordingly, the sensor for the diagnostic device according to the present invention is advantageous in that it has a relatively short diagnostic time and excellent sensitivity and selectivity to a specific substance. Outer advantages are that the sensor may be repeatedly used many times and applied to various fields, and various diagnoses can conducted for a relatively short time through a simple operation in which various diagnostic kits are replaced with each other.

### TECHNICAL FIELD

The present invention pertains to a sensor for a diagnostic device using an optical fiber and a pH sensitive high molecular weight substance, which indicates the safety of foodstuffs or is used as a medical examination device. More particularly, the present invention relates to a sensor for a diagnostic device which detects a wavelength change of reflected light using an optical spectroscope to indicate a freshness of foodstuffs or an immune condition of a human body, including a light receiving optical fiber through which light is transferred from a light source to a pH sensitive high molecular weight substance. The sensor also includes a semi-permeable membrane film part which is filled with the pH sensitive high molecular weight substance so as to detect a pH change of a subject when the subject comes into contact with the pH sensitive high molecular weight substance, receives an output end of the light receiving optical fiber and an input end of an information transferring optical fiber, and includes a reflection member inserted therein so as to reflect the light passing through the light receiving optical fiber into the information transferring optical fiber. The information transferring optical fiber transfers data including the freshness of the foodstuffs or a health condition of the human body therethrough when the light subjected to a wavelength interference by the pH sensitive high molecular weight substance advances into the optical spectroscope. Alternatively, the sensor for the diagnostic device may includes a diagnostic kit insertion member instead of the semi-permeable membrane film part. The diagnostic kit insertion member is made of a material having excellent light transmittance, receives an output end of the light receiving optical fiber and an input end of the information transferring optical fiber, and has a diagnostic kit insertion groove for receiving a diagnostic kit. At this time, the diagnostic kit includes a semi-permeable membrane member and the pH sensitive high molecular weight substance. Accordingly, the sensor for the diagnostic device according to the present invention is advantageous in that it has a relatively short diagnostic time and excellent sensitivity and selectivity to a specific substance. Other advantages are that the sensor may be repeatedly used many times and applied to various fields, and various diagnoses can conducted for a relatively short time through a simple operation in which various diagnostic kits are replaced with each other.

### BACKGROUND ART

Since Clark has developed an initial glucose sensor using a dialysis membrane to detect glucose in 1962, many studies of a biosensor have been made in various engineering fields, such as biological engineering, chemical engineering, electronic engineering, life engineering, and computer engineering. The biosensor is usually defined as a system converting information obtained from a subject into recognizable signals such as colors, fluorescent signals, and electrical signals, using biological elements or something imitating the biological elements.

One example of the simplest biosensors is a pregnancy diagnosis kit. The pregnancy diagnosis kit functions to detect a specific hormone (subject) existing in the urine of women who may be pregnant using antibodies (biological element) to allow users to identify whether they are pregnant or not through a recognizable signal (color) of the pregnancy diagnosis kit. Furthermore, a blood sugar measuring device useful to diabetics is one of the representative biosensors. The blood sugar measuring device is operated based on a mechanism that electrons generated when hydrogen peroxide produced while glucose (subject) in blood is oxidized by a glucose oxidase (biological element) is converted into oxygen are converted into an electric current (signal) using electrodes, thereby an amount of blood sugar is measured. Currently, devices, such as the blood sugar measuring device, capable of detecting the subject to produce recognizable signals are comprehensively called as sensors.

Meanwhile, the biosensor is classified into an enzyme sensor, a microorganism sensor, a tissue sensor, and an immune sensor according to a receiver. Additionally, an enzyme and an antibody are most frequently used as a sensor matrix because a sensor substance or a sensor used in the biosensor must have high selectivity and sensitivity to the subject.

However, most of conventional biosensors are disadvantageous in that their response time is long, their application fields are limited even though they have high selectivity to the subject, they have relatively short life span because they have poor thermal/chemical stability.

### DISCLOSURE OF THE INVENTION

Accordingly, the present invention has been made keeping in mind the above problems occurring in the prior art, and an aspect of the present invention is to provide a sensor for a diagnostic device, which has advantages in that it has a relatively short diagnostic time and excellent sensitivity and selectivity to a specific substance. Other advantages of the sensor are that the sensor may be repeatedly used many times and applied to various fields, and various diagnoses can conducted for a relatively short time through a simple operation in which various diagnostic kits are replaced with each other.

Additional aspects and/or advantages of the invention will be set forth in part in the description which follows and, in part, will be obvious from the description, or may be learned by practice of the invention.

The above and/or other aspects are achieved by providing a sensor for a diagnostic device which detects a wavelength change of reflected light using an optical spectroscope to indicate a freshness of foodstuffs or an immune condition of a human body, including a light receiving optical fiber through which light is transferred from a light source to a pH sensitive high molecular weight substance. The sensor also includes a semi-permeable membrane film part which is filled with the pH sensitive high molecular weight substance so as to detect a pH change of a subject when the subject comes into contact with the pH sensitive high molecular weight substance, receives an output end of the light receiving optical fiber and an input end of an information transferring optical fiber, and includes a reflection member inserted therein so as to reflect the light passing through the light receiving optical fiber into the information transferring optical fiber. The information transferring optical fiber transfers data including the freshness of the foodstuffs or a health condition of the human body therethrough when the light subjected to a wavelength interference by the pH sensitive high molecular weight substance advances into the optical spectroscope. Alternatively, the sensor for the diagnostic device may include a diagnostic kit insertion member instead of the semi-permeable membrane film part. The diagnostic kit insertion member is made of a material having excellent light transmittance, receives an output end of the light receiving optical fiber and an input end of the information transferring optical fiber, and has a diagnostic kit insertion groove for receiving a diagnostic kit. At this time, the diagnostic kit includes a semi-permeable membrane member and the pH sensitive high molecular weight substance. Accordingly, the sensor for the diagnostic device according to the present invention is advantageous in that it has a relatively short diagnostic time and excellent sensitivity and selectivity to a specific substance. Other advantages are that the sensor may be repeatedly used many times and applied to various fields, and various diagnoses can conducted for a relatively short time through a simple operation in which various diagnostic kits are replaced with each other.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view of a sensor for a diagnostic device according to the first embodiment of the present invention, which includes optical fibers and a pH sensitive high molecular weight substance;

FIG. 2 is a sectional view taken along the line A-A′ of FIG. 1;

FIG. 3 is a sectional view of a sensor for a diagnostic device according to the second embodiment of the present invention, which includes optical fibers and a pH sensitive high molecular weight substance;

FIG. 4 illustrates a structure of a diagnostic kit applied to the sensor of FIG. 3; and

FIG. 5 is a graph showing the transparency of the pH sensitive high molecular weight substance as a function of pH of a subject for the sensor for the diagnostic device according to the present invention.

### BEST MODE FOR CARRYING OUT THE INVENTION

Reference should now be made to the drawings, in which the same reference numerals are used throughout the different drawings to designate the same or similar components.

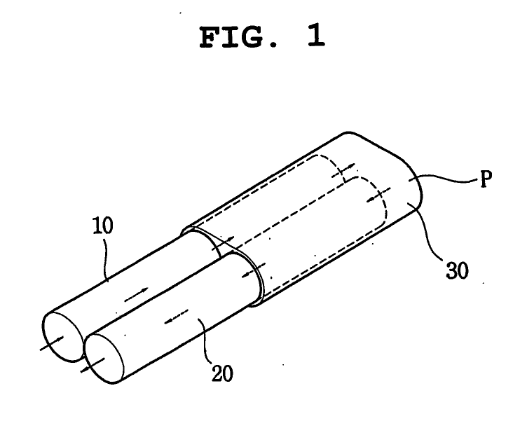

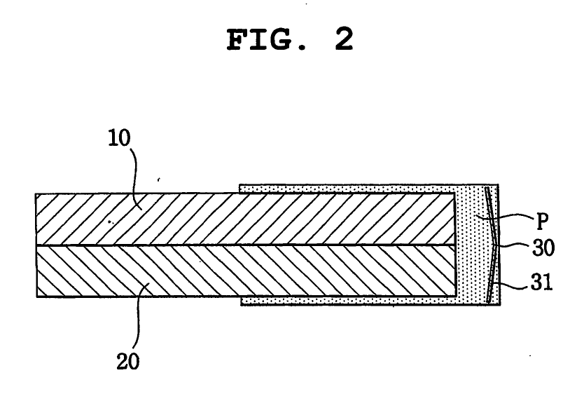

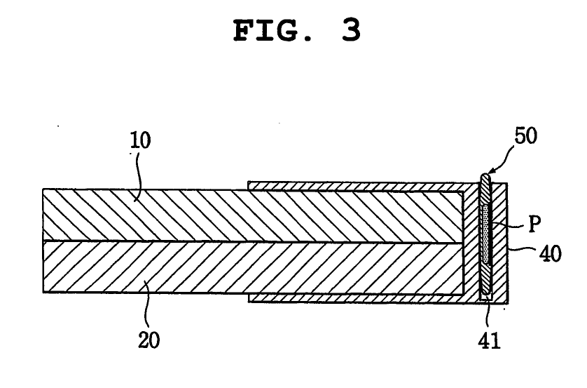

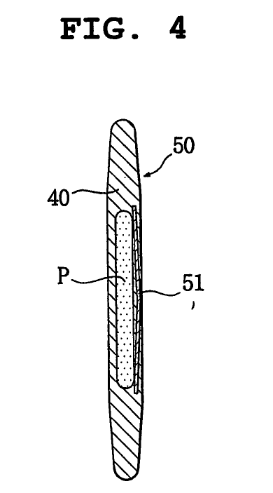

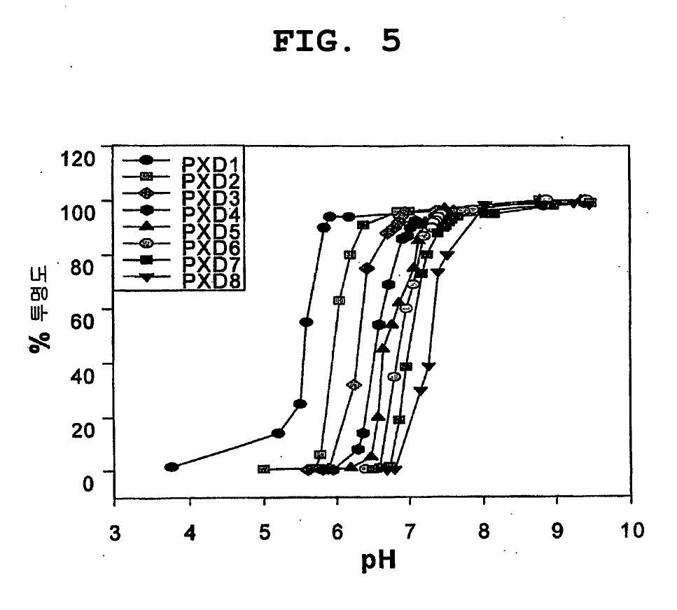

As shown in the drawings, FIG. 1 is a perspective view of a sensor for a diagnostic device according to the first embodiment of the present invention, which includes optical fibers and a pH sensitive high molecular weight substance, FIG. 2 is a sectional view taken along the line A-A′ of FIG. 1, FIG. 3 is a sectional view of a sensor for a diagnostic device according to the second embodiment of the present invention, which includes optical fibers and a pH sensitive high molecular weight substance, FIG. 4 illustrates a structure of a diagnostic kit applied to the sensor of FIG. 3, and FIG. 5 is a graph showing the transparency of the pH sensitive high molecular weight substance as a function of pH of a subject for the sensor for the diagnostic device according to the present invention.

According to the first embodiment of the present invention, the sensor for the diagnostic device which detects a wavelength change of reflected light using an optical spectroscope to indicate a freshness of foodstuffs or an immune condition of a human body, includes a light receiving optical fiber 10 through which light is transferred from a light source to a pH sensitive high molecular weight substance (P). Additionally, a semi-permeable membrane film part 30 is filled with the pH sensitive high molecular weight substance (P) so as to detect a pH change of a subject when the subject comes into contact with the pH sensitive high molecular weight substance (P), receives an output end of the light receiving optical fiber 10 and an input end of an information transferring optical fiber 20, and includes a reflection member 31 inserted therein so as to reflect the light passing through the light receiving optical fiber 10 into the information transferring optical fiber 20. The information transferring optical fiber 20 transfers data including the freshness of the foodstuffs or a health condition of the human body therethrough when the light subjected to a wavelength interference by the pH sensitive high molecular weight substance (P) advances into the optical spectroscope.

According to the second embodiment of the present invention, the sensor for the diagnostic device which detects a wavelength change of reflected light using an optical spectroscope to indicate a freshness of foodstuffs or an immune condition of a human body, includes a light receiving optical fiber 10 through which light is transferred from a light source to a pH sensitive high molecular weight substance (P). Furthermore, an information transferring optical fiber 20 transfers data including the freshness of the foodstuffs or a health condition of the human body therethrough when the light subjected to a wavelength interference by the pH sensitive high molecular weight substance (P) advances into the optical spectroscope. The sensor also includes a diagnostic kit insertion member 40 made of a material having excellent light transmittance, which receives an output end of the light receiving optical fiber 10 and an input end of the information transferring optical fiber 30 and has a diagnostic kit insertion groove 41 for receiving a diagnostic kit 50. The diagnostic kit 50 includes a semi-permeable membrane member 51 and the pH sensitive high molecular weight substance (P).

In FIG. 1, the semi-permeable membrane film part 30 includes a semi-permeable membrane at a predetermined position thereof. A remaining portion other than the semi-permeable membrane of the semi-permeable membrane film part 30 may be made of any material so long as the material does not affect the light passing therethrough. When ions and solvents of a subject pass through the semi-permeable membrane of the semi-permeable membrane film part 30 or the semi-permeable membrane member 51, the ions and solvents ionize and deionize the pH sensitive high molecular weight substance (P) to allow the pH sensitive high molecular weight substance (P) to have a transparent phase or an opaque phase, thereby affecting properties of the light, for example a wavelength interference phenomenon occurs. At this time, the changed properties, that is, the changed wavelength of the light is analyzed by an optical spectroscope, thereby a freshness of the subject or a health condition of a human body is evaluated.

Any semi-permeable membrane may be used in the semi-permeable membrane film part 30 or semi-permeable membrane member 51 so long as it allows only the ions and solvents contained in the foodstuffs to penetrate therethrough. Further, sulfonamide reacts with methacryloyl chloride to produce a pH sensitive monomer, and the pH sensitive monomer thus produced reacts with N,N-dimethylacrylamide as a monomer in various molar ratios to produce plural pH sensitive high molecular weight substance samples.

Examples of usable sulfonamides include sulfadiazine, sulfabenzamide, sulfacetamide, sulfisoxazole, sulfamethizole, sulfadimethoxine, sulfapyridine, sulfamethazine, sulfisomidine, and sulfamethoxypyridazine.

A procedure of producing a pH sensitive monomer using sulfadiazine is shown in following Reaction equation 1.

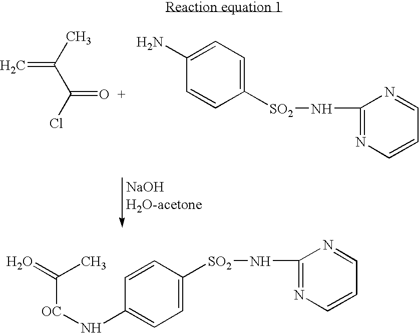

Furthermore, a procedure of reacting the pH sensitive monomer, for instance a sulfadimethoxine monomer, with N,N-dimethylacrylamide as a monomer to produce the pH sensitive high molecular weight substance is shown in the following Reaction equation 2.

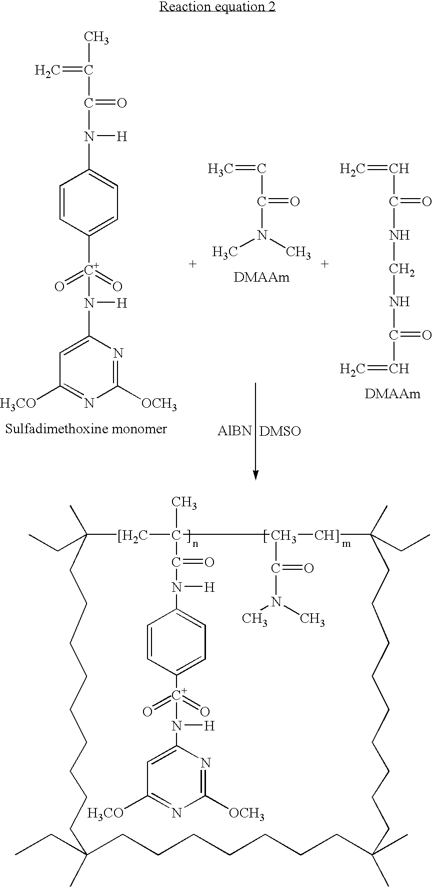

In the Reaction equation 2, MBAAm is a crosslinker, and AIBN is an initiator.

Meanwhile, after the pH sensitive monomer reacts with N,N-dimethylacrylamide as the monomer in various molar ratios to produce plural pH sensitive high molecular weight substance samples, the pH sensitive high molecular weight substance most suitable in a desired pH range is selected.

For example, sulfadiazine (methacryloyl chloride) which is the pH sensitive monomer may be reacted with N,N-dimethylacrylamide in molar ratios of 1:9, 2:8, and 3:7. At this time, a swelling ratio of the pH sensitive high molecular weight substance depends on the molar ratio, thus the molar ratio change affects the transparency of the pH sensitive high molecular weight substance.

The swelling ratio of the pH sensitive high molecular weight substance denotes the degree of water held in the pH sensitive high molecular weight substance. Accordingly, if the swelling ratio of the pH sensitive high molecular weight substance is low at pH 5 and is high at pH 6, the pH sensitive high molecular weight substance holds more water at pH 6 than at pH 5. At this time, the swelling ratio change of the pH sensitive high molecular weight substance causes the transparency change of the pH sensitive high molecular weight substance.

Additionally, a variable pH range of the pH sensitive high molecular weight substance is proportionally increased with a sulfadiazine (methacryloyl chloride) content in the pH sensitive high molecular weight substance. From the following Table 1, it can be seen that when sulfadiazine reacts with N,N-dimethylacrylamide in a molar ratio of 1:9, the variable pH range is about six, but when sulfadiazine reacts with N,N-dimethylacrylamide in a molar ratio of 2:8, the variable pH range is six or higher. Therefore, the variable pH range is controlled using the molar ratio of sulfadiazine(methacryloyl chloride) which is the pH sensitive monomer and N,N-dimethylacrylamide.

TABLE 1
Swelling ratio

pH

| Molar ratio | 5 | 6 | 7 | 8 |
|---|---|---|---|---|
| 1:9 | 10.4 | 11.22 | 20.47 | 28.67 |
| 2:8 | 10.4 | 14 | 24 | 68 |
| 3:7 | 3.8 | 4.3 | 9.8 | 43 |

In FIG. 5, PXD 1 denotes that sulfadiazine(methacryloyl chloride) which is the pH sensitive monomer reacts with N,N-dimethylacrylamide in a molar ratio of 1:9, and PXD 2 to PXD 8 respectively denote that sulfadiazine(methacryloyl chloride) reacts with N,N-dimethylacrylamide in molar ratios of 2:8, 3:7, 4:6, 5:5, 6:4, 7:3, and 8:2.

Referring to FIGS. 3 and 4, a diagnostic kit 50 is separately produced, and a diagnostic kit insertion member 40 into which the diagnostic kit 50 is removably inserted is combined with optical fibers 10 and 20. In other words, after the diagnostic kit 50 is removably inserted into a diagnostic kit insertion groove 41 of the diagnostic kit insertion member 40, the subject comes into contact with the pH sensitive high molecular weight substance (P) in the diagnostic kit 50. When ions and solvents of the subject pass through the semi-permeable membrane of the semi-permeable membrane member 51, the ions and solvents ionize and deionize the pH sensitive high molecular weight substance (P) to allow the pH sensitive high molecular weight substance (P) to have a transparent phase or an opaque phase, thereby affecting the properties of the light, for example a wavelength interference phenomenon occurs. At this time, the changed properties, that is, the changed wavelength of the light is analyzed by an optical spectroscope, thereby a freshness of the subject or a health condition of a human body is indicated.

### INDUSTRIAL APPLICABILITY

As apparent from the above description, the present invention provides a sensor for a diagnostic device which detects a wavelength change of reflected light using an optical spectroscope to indicate a freshness of foodstuffs or an immune condition of a human body, including a light receiving optical fiber through which light is transferred from a light source to a pH sensitive high molecular weight substance. The sensor also includes a semi-permeable membrane film part which is filled with the pH sensitive high molecular weight substance so as to detect a pH change of a subject when the subject comes into contact with the pH sensitive high molecular weight substance, receives an output end of the light receiving optical fiber and an input end of an information transferring optical fiber, and includes a reflection member inserted therein so as to reflect the light passing through the light receiving optical fiber into the information transferring optical fiber. The information transferring optical fiber transfers data including the freshness of the foodstuffs or a health condition of the human body therethrough when the light subjected to a wavelength interference by the pH sensitive high molecular weight substance advances into the optical spectroscope. Alternatively, the sensor for the diagnostic device may include a diagnostic kit insertion member instead of the semi-permeable membrane film part. The diagnostic kit insertion member is made of a material having excellent light transmittance, receives an output end of the light receiving optical fiber and an input end of the information transferring optical fiber, and has a diagnostic kit insertion groove for receiving a diagnostic kit. At this time, the diagnostic kit includes a semi-permeable membrane member and the pH sensitive high molecular weight substance. Accordingly, the sensor for the diagnostic device according to the present invention is advantageous in that it has a relatively short diagnostic time and excellent sensitivity and selectivity to a specific substance. Other advantages are that the sensor may be repeatedly used many times and applied to various fields, and various diagnoses can conducted for a relatively short time through a simple operation in which various diagnostic kits are replaced with each other.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A sensor for a diagnostic device which detects a wavelength change of reflected light using an optical spectroscope to indicate a freshness of foodstuffs or an immune condition of a human body, comprising:
a light receiving optical fiber through which light is transferred from a light source to a pH sensitive high molecular weight substance;
a semi-permeable membrane film part which is filled with the pH sensitive high molecular weight substance so as to detect a pH change of a subject when the subject comes into contact with the pH sensitive high molecular weight substance, receives an output end of the light receiving optical fiber and an input end of an information transferring optical fiber, and includes a reflection member inserted therein so as to reflect the light passing through the light receiving optical fiber into the information transferring optical fiber; and
the information transferring optical fiber to transfer data including the freshness of the foodstuffs or a health condition of the human body therethrough when the light subjected to a wavelength interference by the pH sensitive high molecular weight substance advances into the optical spectroscope.

2. A sensor for a diagnostic device which detects a wavelength change of reflected light using an optical spectroscope to indicate a freshness of foodstuffs or an immune condition of a human body, comprising:
a light receiving optical fiber through which light is transferred from a light source to a pH sensitive high molecular weight substance;
an information transferring optical fiber to transfer data including the freshness of the foodstuffs or a health condition of the human body therethrough when the light subjected to a wavelength interference by the pH sensitive high molecular weight substance advances into the optical spectroscope; and
a diagnostic kit insertion member made of a material having excellent light transmittance, which receives an output end of the light receiving optical fiber and an input end of the information transferring optical fiber and has a diagnostic kit insertion groove for receiving a diagnostic kit, the diagnostic kit including a semi-permeable membrane member and the pH sensitive high molecular weight substance.

3. The sensor as set forth in claim 1 or 2, wherein the pH sensitive high molecular weight substance is produced by reacting a pH sensitive monomer with N,N-dimethylacrylamide as a monomer after sulfonamide reacts with methacryloyl chloride to produce the pH sensitive monomer.

4. The sensor as set forth in claim 3, wherein the sulfonamide is selected from the group consisting of sulfadiazine, sulfabenzamide, sulfacetamide, sulfisoxazole, sulfamethizole, sulfadimethoxine, sulfapyridine, sulfamethazine, sulfisomidine, and sulfamethoxypyridazine.
